(19) United States
(12) Patent Application Publication
(10) Pub. No.: US 2026/0197090 A1
(43) Pub. Date: Jul. 9, 2026

(54) OPTICAL BALANCED HOMODYNE RECEIVER

(71) Applicants: IMEC VZW, Leuven (BE); UNIVERSITEIT GENT, Gent (BE)

(72) Inventors: Cédric BRUYNSTEEN, Gent (BE); Xin YIN, Sint-Denijs-Westrem (BE)

(21) Appl. No.: 19/131,526

(22) PCT Filed: Nov. 21, 2023
(86) PCT No.: PCT/EP2023/082477

§ 371 Date: May 20, 2025

(30) Foreign Application Priority Data
Nov. 21, 2022 (EP) 22208612.6

(51) Int. Cl. H04B 10/63; H04B 10/61

(52) U.S. Cl. CPC H04B 10/63; H04B 10/615; H04B 10/616

(57) ABSTRACT

An optical balanced homodyne receiver (300) has an optical mixing element (320) configured to convert a modulated optical input signal (311) into a pair of demodulated optical signals (321, 322) and an opto-electric conversion circuitry (330) configured to convert the pair of demodulated optical signals into a demodulated electrical current signal (331). The homodyne receiver also has a transimpedance, TI, amplifier (360) with capacitive feedback configured to convert the demodulated electrical current signal to a demodulated electrical voltage signal (361) and a DC current cancellation circuitry (380) configured to measure a low frequency current component in the demodulated electrical current signal and to derive therefrom a feedback signal (381). The optical mixing element is tuneable (323) and configured to receive the feedback signal (381) and to adapt an optical power balance between the pair of demodulated optical signals based on the feedback signal such that the low frequency current component is suppressed.

### TECHNICAL FIELD

Various example embodiments relate, amongst others, to an optical balanced homodyne receiver.

### BACKGROUND

An optical balanced homodyne receiver is a circuitry that performs detection of optical signals, such as signals sent over optical fibres in optical networks. A homodyne receiver detects weak optical signals by mixing them with an optical local oscillator. This mixing causes optical beating between the two signals and generates a more powerful optical output signal that conveys the interference between the two signals. This optical output signal is then fed into a balanced photo-electric conversion circuitry that converts it into an electrical output current. The electrical output current is then converted into a voltage signal by a transimpedance amplifier, TIA or TI amplifier.

An advantage of an optical balanced homodyne receiver is that it enables measurements that are limited by shot noise and cancels a significant amount of technical noise. This technical noise contains the local oscillator's Relative Intensity Noise, RIN, and any other noise or interference which is coupled by the environment to a common-mode path, with the photo-electric biasing circuitry being one of the possible paths.

Different types of transimpedance amplifier architectures are known in the art. A first type combines an inverting voltage amplifier with a feedback resistor, also called a shunt-feedback transimpedance amplifier. The bandwidth of this type of TI amplifier is largely determined by the value of this feedback resistor wherein smaller resistors with a lower resistance yield a larger bandwidth. A disadvantage however is that the smaller the feedback resistor, the larger the amount of white noise. A further disadvantage is that non-idealities in the optical front-end result in undesired DC and low frequency currents at the input of the TI amplifier. Although such undesired currents can be evacuated by the feedback resistor, it will still cause a voltage offset at the output thereby reducing the dynamic range of the amplifier.

A second type of TI amplifier combines a voltage amplifier with a capacitive current divider. The advantage of this TI amplifier is that there is no white noise from a feedback resistor affecting the overall noise performance. However, due to the absence of a DC current path, such TI amplifier is very sensitive to DC and low frequency currents resulting in clipping at the output. One solution to this is to add a current source at the input of the TI amplifier that sources or drains the DC current and low frequency components. However, such current source will again introduce noise thereby reducing the benefits of using capacitive feedback. Furthermore, in deep sub-micron transistor technologies the noise contribution worsens because the drain excess noise factor of the transistors in the current source further increases. Further, while adding a current source solves the issue of DC currents partially, it does not improve the injection of technical noise since this noise cannot be distinguished from the signal when it reaches the TI amplifier. Such leakage of technical noise reduces the sensitivity of the detector.

### SUMMARY

The scope of protection sought for various embodiments of the invention is set out by the independent claims.

The embodiments and features described in this specification that do not fall within the scope of the independent claims, if any, are to be interpreted as examples useful for understanding various embodiments of the invention.

Amongst others, it is an object of embodiments of the invention to provide in an improved optical balanced homodyne receiver.

This object is achieved, according to a first example aspect of the present disclosure, by an optical balanced homodyne receiver comprising: i) an optical mixing element configured to convert a modulated optical input signal into a pair of demodulated optical signals; ii) an opto-electric conversion circuitry configured to convert the pair of demodulated optical signals into a demodulated electrical current signal; iii) a transimpedance, TI, amplifier configured to convert the demodulated electrical current signal to a demodulated electrical voltage signal; and wherein the TI amplifier comprises an inverting voltage amplifier with capacitive feedback; iv) a DC current cancellation circuitry configured to measure a low frequency current component in the demodulated electrical current signal and to derive therefrom a feedback signal; and wherein the optical mixing element is tuneable and configured to receive the feedback signal and to adapt an optical power balance between the pair of demodulated optical signals based on the feedback signal such that the low frequency current component is suppressed.

A low frequency current component is an unwanted current signal that has a spectrum below the bandwidth of interest in the demodulated electrical current signal. Sometimes this is referred to as a DC current but in practice this also extends to low frequency variations of the current signal. The term low frequency current or DC current refers to this same unwanted current signal and is used interchangeably throughout this disclosure.

The effect of DC currents is thus suppressed at the source, i.e. it tackles the process and temperature variations in the optical front-end that includes the optical mixing element and opto-electric conversion circuitry. As a result, the generation of these DC currents is suppressed rather than removing the currents whenever they occur. The claimed solution does not require a current source that generates significant amounts of current at the input node of the TI amplifier. As such, the noise penalty introduced by the large transistors in such current source is avoided. By the tuning of the optical mixing element, the overall common mode rejection will be improved thereby providing an improved rejection of the technical noise caused by the local oscillator. As a result, the optical receiver is more tolerant to process and temperature variations.

Because of the DC suppression, there is no need to have a large current source thereby avoiding the disadvantage of the capacitive feedback. On the other hand, the advantage of having less white noise compared with a shunt-feedback transimpedance amplifier remains. As such, an optical receiver with better noise performance and larger bandwidth is obtained.

According to example embodiments, the DC current cancellation circuitry further comprises a current source for draining residual low frequency current.

In practice, the suppression of the low frequency current will not be ideal because of offsets and finite loop gain. Because of this, a residual low frequency current will still be present at the input of the TI amplifier. This residual DC current may then be removed by a current source circuitry. As the residual DC current will be substantially lower when compared with receivers as known in the art, the current produced by the current source can be made substantially lower and, as such, will introduce much less noise at the input of the TI amplifier.

Such current source may for example be embodied as a stacked n- and p-channel FET transistor pair that operates as a source follower. According to further embodiments, the transistor pair is configured to operate in subthreshold level. As a result, only very little current will flow through the transistors when there are no DC currents present thereby creating very little noise. On the other hand, because of the crossover distortion this current source has the possibility to sink or source significant amounts of current when needed, e.g. when the feedback loop is settling.

According to example embodiments the DC current cancellation circuitry further comprises an input current monitoring circuitry configured to measure the residual low frequency current drained by the current source. According to further example embodiments, the input current monitoring circuitry is a second current source that is matched to the current source and outputs a residual current signal characterizing the residual low frequency current drained by the current source. This second current source may also be embodied as a stacked transistor pair.

This allows obtaining a precise feedback signal that does not interfere with the first current source. This way, there is no path between this current source and the input node. This further prevents noise generated by the second current source from coupling to the sensitive input node.

According to further embodiments, the DC current cancellation circuitry further comprises a driver circuitry configured to convert the residual current signal to the feedback signal.

According to example embodiments, the optical balanced homodyne receiver is further configured in a differential operating mode. This further results in less sensitivity to undesired common-mode signals and improves the power supply rejection ratio.

In such differential operating mode, the mixing element may comprise two two-by-two tuneable mixers respectively driving two opposite opto-electric conversion circuitries thereby generating a pair of demodulated electrical current signals having a differential signal mode component. As the optical input signal is a single mode signal by design, the two opposite opto-electric conversion circuitries convert this single mode signal to a differential current signal. Further, as both mixers are tuneable, the DC cancellation circuitry can measure the DC currents in both demodulated electrical current signals and separately adjust the mixing ratios of the respective tuneable mixers. As a result, undesired DC currents from process variations between the two opposite opto-electric conversion circuitries can also be suppressed.

According to example embodiments, the optical balanced homodyne receiver is further configured in a single-ended operating mode.

According to example embodiments, the optical mixing element comprises a Mach-Zehnder interferometer, a multimode interferometer with variable optical attenuators in each output arm, or a multimode interferometer with heat gradient.

### BRIEF DESCRIPTION OF THE DRAWINGS

Some example embodiments will now be described with reference to the accompanying drawings.

FIG. 1 shows an optical balanced homodyne receiver with a shunt-feedback transimpedance amplifier according to the state of the art;

FIG. 2 shows an optical balanced homodyne receiver with a capacitive current divider according to the state of the art;

FIG. 3 shows an optical balanced homodyne receiver according to an example embodiment;

FIG. 4 shows an optical balanced homodyne receiver according to an example embodiment;

FIG. 5 shows an electrical signal processing circuitry of an optical balanced homodyne receiver according to an example embodiment;

FIG. 6 shows a differential optical balanced homodyne receiver according to an example embodiment; and

FIG. 7 shows a differential optical balanced homodyne receiver according to an example embodiment.

### DETAILED DESCRIPTION OF EMBODIMENT(S)

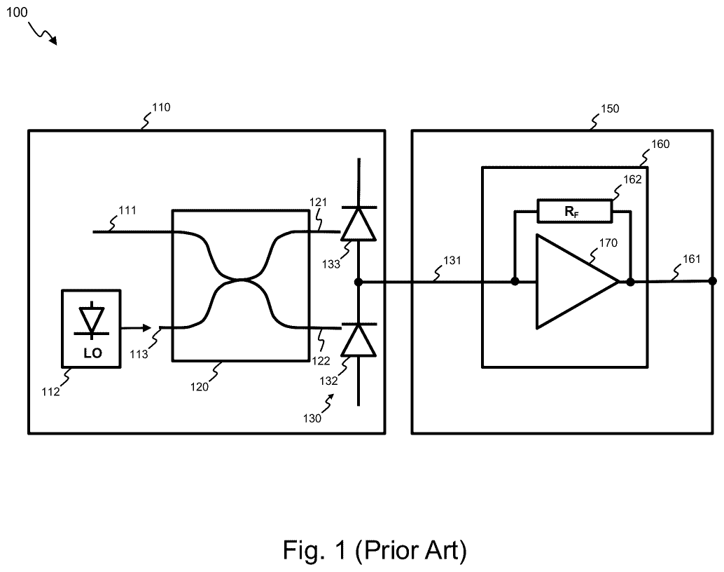

FIG. 1 shows an optical balanced homodyne receiver 100 with a shunt-feedback transimpedance amplifier 160 according to the state of the art. Receiver 100 comprises an opto-electric circuitry 110 that converts a modulated optical input signal 111 receivable at its input to a demodulated electrical current signal 131 at its output. Circuitry 110 comprises a local oscillator 112 that generates a local oscillating optical signal 113. Circuitry 110 further comprises an optical mixing element 120 that mixes the local oscillating optical signal 113 with the received optical signal 111. This mixing causes an optical beating within the optical mixing element 120 between the two signals and generates a more powerful pair of optical output signals 121, 122 that conveys the interference between the two signals 111 and 113. Circuitry 110 further comprises an opto-electric conversion circuitry 130 that converts the pair of demodulated optical signals 121, 122 into the demodulated electrical current signal 131. Opto-electric conversion circuitry 130 comprises two opto-electric conversion elements 132, 133 that convert the respective demodulated optical signals 122, 123 into electrical currents. When mixing element 120 has an ideal 50% mixing ratio and when the two opto-electric conversion elements 132, 133 are the same, the direct currents, DC currents, generated by the opto-electric conversion elements 132, 133 will cancel out each other and the demodulated electrical current signal 131 will have no DC current and thus will be an alternating current, AC current, characterizing the communication signal from the input signal 111. Due to non-idealities, circuitry 110 will not be ideally balanced. This imbalance will result in undesired DC current in the demodulated electrical current signal 131.

Receiver 100 further comprises an electrical signal processing circuitry 150 that converts the demodulated electrical current signal 131 at its input to a demodulated electrical voltage signal 161 at its output. To this end, circuitry 150 comprises a transimpedance, TI, amplifier 160 that converts and amplifies the demodulated electrical current signal 131 to demodulated electrical voltage signal at its output. TI amplifier 160 further comprises an inverting voltage amplifier 170 with a feedback resistor 162. When voltage amplifier 170 is based on field-effect transistors, FETs, the noise performance of TI amplifier 160 will be largely determined by the input FET of the voltage amplifier 170 and the feedback resistor 162. The larger the feedback resistor 162, the less noise is generated. On the other hand, the larger the feedback resistor 162, the lower the achievable bandwidth. This results in a trade-off between the noise performance and bandwidth of TI amplifier 160.

Feedback resistor 162 provides a DC path at the input node. This allows handling the undesired DC and low-frequency currents in the demodulated electrical current signal 131 to some extent. For low noise applications the feedback resistor 162 has to be sized to a large value to improve the overall noise performance TI amplifier 160. On the other hand, a large feedback resistor 162 combined with significant amounts of DC currents will result in a large voltage drop over this feedback resistor 162. This will cause the operating point to shift. As the DC current is caused by non-idealities and is thus random, it is not possible to predict the amount of DC current or even the sign of the DC current. The unknown shift in operating point compared to the ideal nominal point reduces the dynamic range of the TI amplifier because the DC current will change and thus shift the output voltage to a lower or higher value, depending on the sign of the DC current.

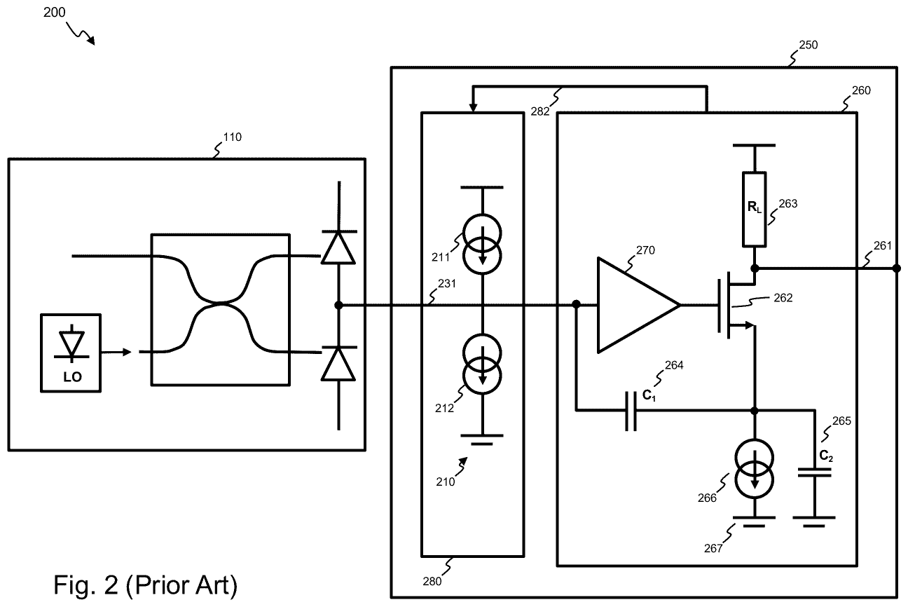

FIG. 2 shows an optical balanced homodyne receiver 200 with a capacitive current divider according to the state of the art. Receiver 200 comprises an opto-electric circuitry 110 similar to the one of FIG. 1 but has a different electrical signal processing circuitry 250. Circuitry 250 comprises a transimpedance, TI, amplifier 260 that converts and amplifies the demodulated electrical current signal 231 to a demodulated electrical voltage signal 261 at its output. TI amplifier 260 further comprises an inverting voltage amplifier 270 and an output stage. The output stage comprises an output transistor 262, a load resistor 263 and DC current source 266 to ground 267. TI amplifier 260 further provides capacitive feedback by a capacitive current divider by means of capacitors 264 and 265. In comparison with FIG. 1, TI amplifier 260 has a better noise performance at frequencies below its corner frequency because the white noise component of resistor 162 is avoided.

A problem with the TI amplifier 260 is that there is no DC path present at the input node 231 of the capacitive current divider. Therefore, no unwanted DC and low frequency currents can be tolerated as this would directly cause saturation and clip the output signal 261 of the TI amplifier 260. Therefore, a high common-mode rejection ratio, CMRR, is required to keep the residual DC currents significantly lower than the weak input signal of interest. Furthermore, such a high CMRR would also cancel a large part of the technical noise generated by the local oscillator 112.

To overcome the DC currents and thus to increase the CMRR, circuit 250 further comprises a DC current cancellation circuitry 280 in the form of a current source 210 that dynamically drains 212 or sources 211 the DC current. This current source is driven by a signal 282 that characterizes the amount of DC current. Although the current source 210 will cancel the DC current, it also has some disadvantages. First, the current source will again introduce extra noise into the input signal path. Second, it does not improve the rejection of technical noise present in the local oscillator because the technical noise is present over a wide frequency range and is therefore not cancelled by only removing the DC component. Third, having large transistors, capable of conducting a large DC current, increases the input capacitance of the circuit 250 which also negatively affects the noise and bandwidth performance.

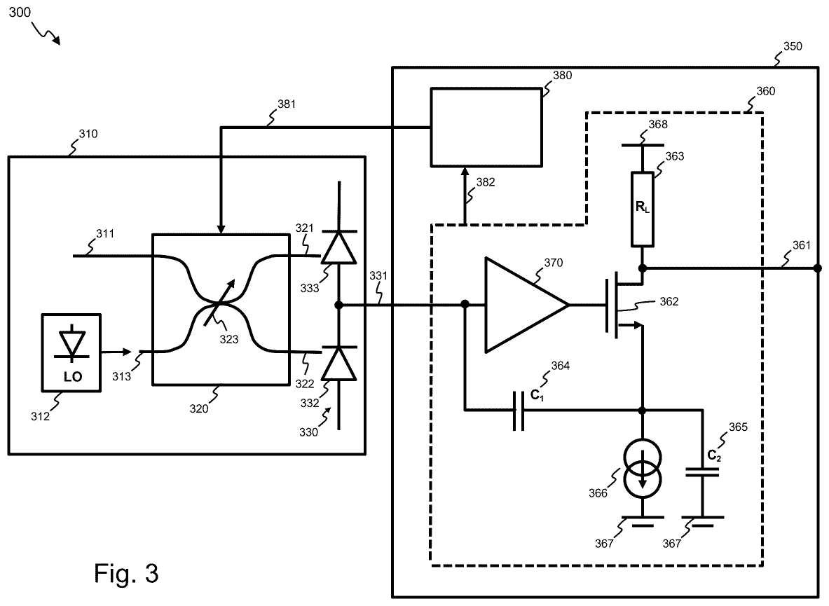

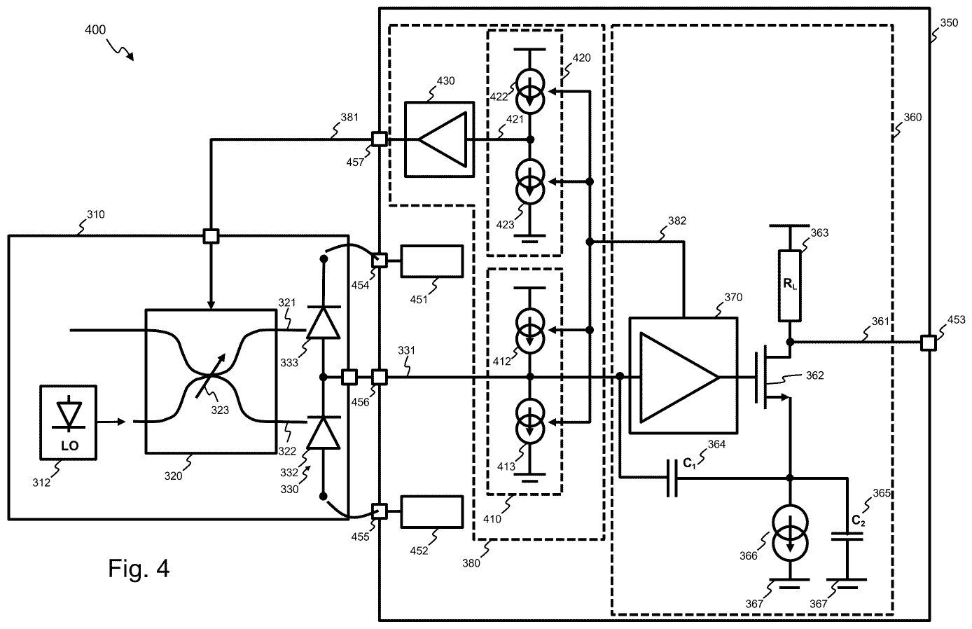

FIG. 3 shows an optical balanced homodyne receiver 300 according to an example embodiment. The receiver 300 illustrates a solution to suppress the above-described DC and low frequency currents occurring at the input node of the electrical signal processing circuitry. FIGS. 4, 5, and 6 describe further embodiments of receiver 300 that apply the same principle for suppressing undesired low frequency currents.

Receiver 300 comprises an opto-electric circuitry 310 that converts a modulated optical input signal 311 at its input to a demodulated electrical current signal 331 at its output. Circuitry 310 comprises a tuneable optical mixing element 320 that converts the modulated optical input signal 311 to a pair of demodulated optical signals 321, 322. This conversion is performed by mixing the modulated optical input signal 311 with a locally generated optical signal 313. Such local optical signal 313 may be generated by a local oscillator 312. The mixing causes an optical beating within the optical mixing element 320 between the two signals and generates a more powerful pair of optical output signals 321, 322 that conveys the interference between the two signals 311 and 313. Mixing element 320 has a tuneable mixing ratio around a 50% mixing ratio. Such tuneable optical mixing element 320 may for example be realized by a Mach-Zehnder interferometer, a multimode interferometer with variable optical attenuators in each output arm, or a multimode interferometer with heat gradient. A Mach-Zehnder interferometer may achieve a tuning range close to 0% to 100%. A multimode interferometer with heat gradient may achieve a tuning range around 45% to 55%

Circuitry 310 further comprises an opto-electric conversion circuitry 330 that is configured to convert the pair of demodulated optical signals into the demodulated electrical current signal 331. Opto-electric conversion circuitry 330 may be the same as opto-electric conversion circuitry 130 as described with reference to FIGS. 1 and 2. As such, when mixing element 320 is tuned to a 50% mixing ratio and when the two opto-electric conversion elements 332, 333 are exactly matched, the direct currents, DC currents, generated by the opto-electric conversion elements 332, 333 will cancel out each other and the demodulated electrical current signal 331 will have no DC current and thus be an alternating current, AC current, characterizing the input signal 311. Opto-electric conversion elements 332, 333 may be realized by photodiodes that produce electrical current according to the received light from optical signals 321, 322.

In a practical realization, circuitry 310 may exhibit different non-idealities such that it is not perfectly balanced. One non-ideality may be that the mixing element does not have a 50% mixing ratio although it is tuned as such by signal 381. This will cause an imbalance in the optical signals 321, 322 that cause an undesired DC current and low frequency current in output current signal 331. Another non-ideality may be that the two opto-electric elements 332 and 333 are not exactly matched due to process variations which will also cause an offset DC current at the output 331. All these non-idealities together will cause a penalty in the common mode rejection ratio, resulting in an undesired DC component and technical noise from the optical local oscillator to be present in the output signal 331. This technical noise contains Relative Intensity Noise, RIN, and any noise or interference which is coupled by the environment to the optical local oscillator.

Receiver 300 further comprises an electrical signal processing circuitry 350 that converts the demodulated electrical current signal 331 at its input to a demodulated electrical voltage signal 361 at its output. Circuitry 350 comprises a transimpedance, TI, amplifier 360 that converts and amplifies the demodulated electrical current signal 331 to a demodulated electrical voltage signal 361 at its output. TI amplifier 360 may be realized the same way as TI amplifier 260. As such TI amplifier 360 can comprise an inverting voltage amplifier 370 and an output stage. The output stage comprises an output transistor 362, a load resistance 363 between a power supply node 368 and output node 361, and a DC current source 366 to ground 367. TI amplifier 360 further provides capacitive feedback by a capacitive current divider formed by means of capacitors 364 and 365.

Electrical signal processing circuitry 350 further comprises a DC current cancellation circuitry 380 that measures the undesired low frequency current component in the demodulated electrical current signal 331 derives therefrom feedback signal 381. Feedback signal 381 then steers the tuneable mixing element 320 such that the optical power balance between the pair of demodulated optical signals 321, 322 is adapted in such a way that the measured low frequency current component detected in signal 331 is suppressed. In other words, a feedback mechanism is obtained between the electrical signal processing circuitry 350 and the opto-electric circuitry 310.

FIG. 4 illustrates an optical balanced homodyne receiver 400 according to an example embodiment. Receiver 400 is a possible implementation of receiver 300, more particular of the DC current cancellation circuitry 380. In receiver 400, cancellation circuitry 380 comprises a first current source 410 that is controlled by feedback signal 382. First current source 410 is configured to remove the residual DC and low frequency current components from input current signal 331. First current source 410 comprises a sourcing current source 412 that will source or add current to signal 331 when feedback signal 382 indicates a negative low frequency current component. Similarly, first current source 410 comprises a draining current source 413 that will drain current from current signal 331 when feedback signal 382 indicates a positive low frequency current component. The feedback signal 382 is further fed into a second current source 420 also comprising a sourcing current source 422 and a draining current source 423. The second current source 420 is matched with the first current source 410. As such, second current source 420 will produce the same compensating currents at its output 421 than the first current source. As such, signal 421 characterizes the undesired low frequency current component in current signal 331. This signal is then converted into feedback signal 381 by a buffering circuitry 430 that adapts the signal 421 to the specific format needed by mixing element 320.

In a practical implementation, receiver 400 can be realized as two separate integrated circuits that are then connected together. The first integrated circuit is then opto-electric circuitry 310 that houses all optical components. The second integrated circuity is then electrical signal processing circuitry 350 that houses all electrical components. Circuit 350 then comprises an output terminal 453 that outputs output signal 361. Circuit 350 also comprises terminals 454, 455 that connects respective bias voltage sources 451, 452 with the opto-electric elements 332, 333. Circuit 350 also comprises terminal 456 that receives the output current signal 331 from opto-electric circuitry 310. Circuit 350 also comprises terminal 457 that outputs feedback signal 381 to connect it with tuneable mixing element 320.

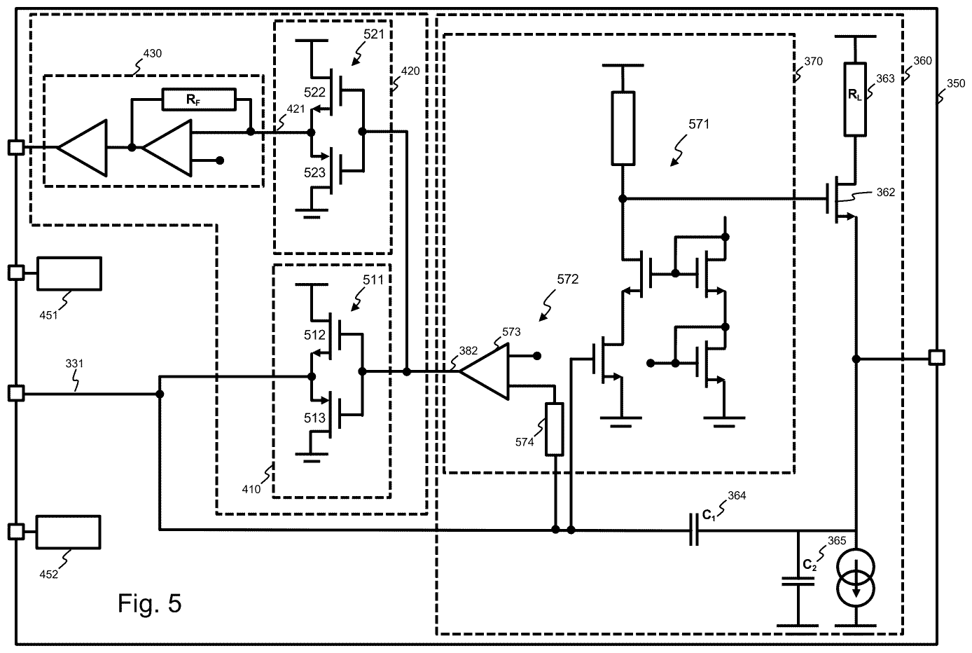

FIG. 5 illustrates electrical signal processing circuitry 350 according to a further example embodiment. Circuitry 350 of FIG. 5 is a possible and further detailed implementation of the electrical signal processing circuitry 350 that is shown in FIGS. 3 and 4. Only the further details will be described with reference to FIG. 5.

TI amplifier 360 is shown with further details of the inverting voltage amplifier 370 having an inverting amplification stage 571 and a circuitry 572 for generating feedback signal 382. In this example, amplification stage 571 is realized as a cascoded common-emitter stage with a resistive load. Alternatively, other types of suitable amplification stages as known in the art may be chosen. Other examples may include but are not limited to single stage amplifiers such as inverters, non cascoded common emitter stages with active or resistive loads, or to multi-stage inverting amplifiers.

Feedback signal 382 is created by sensing the input signal 331 by means of sensing circuitry 573. A resistor 574 is provided between the input signal 331 and sensing circuitry 573 to shield the input capacitance of sensing circuitry 573 from the actual amplification stage 571. Instead of input signal 331, other nodes within TI amplifier 360 may be selected for generating the feedback signal 382. The selected node will influence the loop-gain of the feedback loop.

The first current source 410 may be provided in the form of an n-channel FET transistor 512 for sourcing the residual current and in the form of a p-channel FET transistor 513 for draining the residual current. Both transistors are driven by feedback signal 382 at their gate. As such, transistor pair 511 operates as a source follower. Preferably, the transistor pair is configured to operate in subthreshold level when there is no residual low frequency current present. As such, when the remaining DC current is sufficiently low, the noise penalty added by the first current source 511 is negligible.

The second current source 420 may also be provided in the form of an n-channel FET transistor 522 and a p-channel FET transistor 523. Transistors 522 and 523 are respectively matched with transistors 512 and 513 so as to form matched transistor pairs 511, 521. This way, output signal 421 is a representation of the undesired DC current measured at the input node 331. Buffer circuitry 430 may then convert the measured current by a first current-to-voltage amplification stage and a subsequent buffer stage.

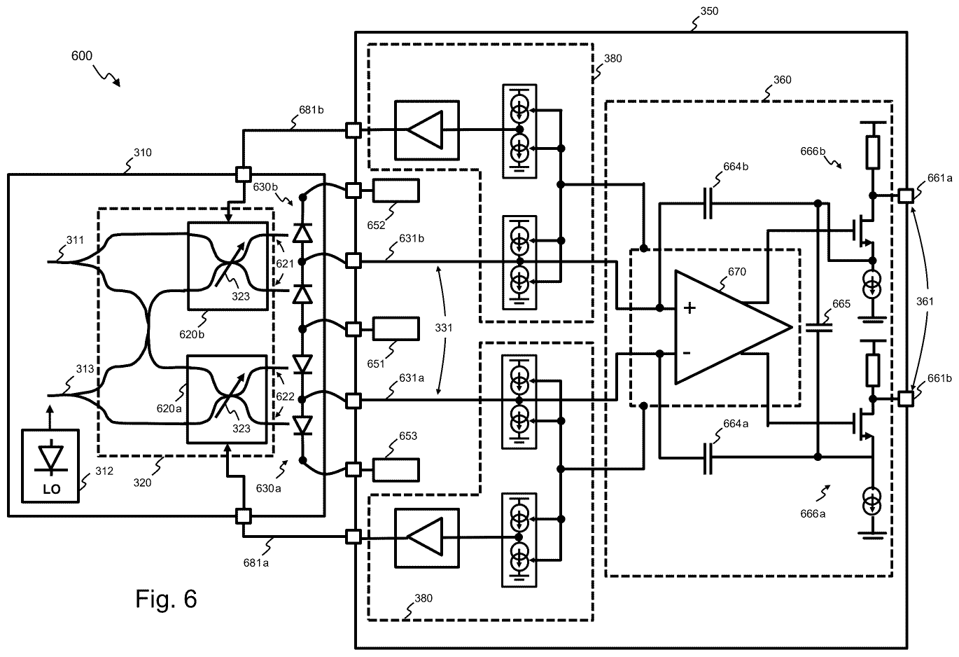

FIG. 6 illustrates an optical balanced homodyne receiver 600 according to an example embodiment. Receiver 600 is functionally identical to receiver 400 except that it is configured in a differential operating mode instead of in a single-ended operating mode. To this end, opto-electric circuitry 310 now comprises a tuneable mixing element 320 with two tuneable mixers 620a, 620b. Each tuneable mixer mixes the optical input signal with the locally generated signal 313 each producing a pair 621, 622 of demodulated signals. Each pair 621, 622 of these signals drive respective opto-electric conversion circuitries 630a, 630b that output respective positive and negative current signals 631a, 631b carrying an opposite representation of input signal 311. The opto-electric conversion circuitries 630a, 630b are further biased by voltage sources 651, 652, and 653. The difference between the current signals 631a and 631b then forms the differential demodulated electrical current signal 331. The electrical signal processing circuitry 350 contains a DC current cancellation circuitry 380 for suppressing unwanted low frequency currents from both the positive and negative current signals 631a and 631b. This may be realised by providing the DC current cancellation circuitry 380 as described with reference to FIGS. 3, 4, and 5 to both the negative and positive input nodes 631a and 631b. As such, first and second feedback signals 681a and 681b are generated to steer the mixing ratio of respective tuneable mixers 620a and 620b. As a result, the undesired DC and low frequency currents occurring and measured from nodes 631a and 631b will be suppressed by these two feedback mechanisms.

The differential demodulated electrical current signal 331 is further amplified to the demodulated electrical differential voltage signal 361 characterized by the difference between the positive and negative output nodes 661a and 661b. The amplification is done by a differential transimpedance amplifier 360 having a differential voltage amplifier 670, separate output stages 666a, 666b, and arranged with a capacitive current divider by means of capacitors 664a, 664b and 665.

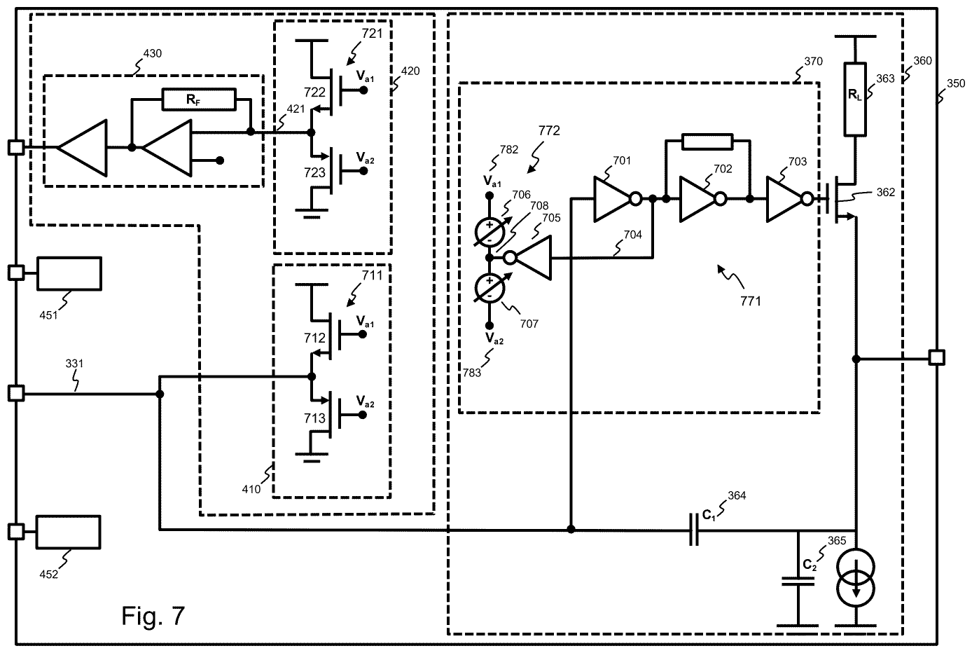

FIG. 7 illustrates electrical signal processing circuitry 350 according to a further example embodiment. Circuitry 350 of FIG. 7 is a possible and further detailed implementation of the electrical signal processing circuitry 350 that is shown in FIGS. 3 and 4. Only the further details will be described with reference to FIG. 7.

TI amplifier 360 is shown with further details of the inverting voltage amplifier 370 having an inverting amplification stage 771 and a circuitry 772 for generating feedback signals 782 and 783. In this example, amplification stage 771 is a multistage inverting amplifier formed by a series of inverters 701, 702, 703.

Feedback signals 782, 783 are creating by sensing the output 704 of the first inverter. Signal 704 is then amplified by a separate inverter 705 resulting in an amplified signal 708. The first feedback signal 782 is then created by adding a first tuneable voltage to the amplified signal 708 by means of the tuneable voltage source 706. The second feedback signal 783 is created by subtracting a second tuneable voltage from the amplified signal 708 by means of a second tuneable voltage source 707.

Feedback signals 782, 783 are then provided to the first current source 410 and second current source 420. The first current source 410 is provided in the form of an n-channel FET transistor 712 for sourcing the residual current and in the form of a p-channel FET transistor 713 for draining the residual current. Transistor 712 is driven by feedback signal 782 and transistor 713 is driven by feedback signal 783. As such, transistor pair 711 operates as a source follower. By tuning of the voltage sources 706, 707 cross-over distortion in transistor pair 711 can be avoided or minimized.

The second current source 420 is also be provided in the form of an n-channel FET transistor 722 and a p-channel FET transistor 723. Transistors 722 and 723 are respectively matched with transistors 712 and 713 so as to form matched transistor pairs 711, 721. This way, output signal 421 is a representation of the undesired DC current measured at the input node 331. Buffer circuitry 430 may then convert the measured current by a first current-to-voltage amplification stage and a subsequent buffer stage. Similar to transistor pair 711, transistor 722 is driven by feedback signal 782 and transistor 723 is driven by feedback signal 783. As such, transistor pair 721 operates as a source follower. By the tuning of the voltage sources 706, 707 cross-over distortion in transistor pair 721 can be avoided or minimized.

As used in this application, the term “circuitry” may refer to one or more or all of the following:
(a) hardware-only circuit implementations such as implementations in only analog and/or digital circuitry and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and/or processor(s), such as microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. An optical balanced homodyne receiver comprising:
an optical mixing element configured to convert a modulated optical input signal into a pair of demodulated optical signals;
an opto-electric conversion circuitry configured to convert the pair of demodulated optical signals into a demodulated electrical current signal;
a transimpedance, TI, amplifier configured to convert the demodulated electrical current signal to a demodulated electrical voltage signal; and wherein the TI amplifier comprises an inverting voltage amplifier with capacitive feedback; and
a DC current cancellation circuitry configured to measure a low frequency current component in the demodulated electrical current signal and to derive therefrom a feedback signal;
and wherein the optical mixing element is tuneable and configured to receive the feedback signal and to adapt an optical power balance between the pair of demodulated optical signals based on the feedback signal such that the low frequency current component is suppressed.

2. The optical balanced homodyne receiver according to claim 1 wherein the DC current cancellation circuitry further comprises a current source for draining residual low frequency current.

3. The optical balanced homodyne receiver according to claim 2 wherein the current source is controlled by a feedback signal from the TI amplifier.

4. The optical balanced homodyne receiver according to claim 2 wherein the current source comprises a stacked n- and p-channel FET transistor pair operating as a source follower.

5. The optical balanced homodyne receiver according to claim 4 wherein the stacked transistor pair is configured to operate in subthreshold level when there is no residual low frequency current present.

6. The optical balanced homodyne receiver according to claim 2 wherein the DC current cancellation circuitry further comprises an input current monitoring circuitry configured to measure the residual low frequency current drained by the current source.

7. The optical balanced homodyne receiver according to claim 6 wherein the input current monitoring circuitry is a second current source that is matched to the current source and outputs a residual current signal characterizing the residual current drained by the current source.

8. The optical balanced homodyne receiver according to claim 7 wherein the second current source comprises a stacked n- and p-channel FET transistor pair.

9. The optical balanced homodyne receiver according to claim 7 wherein the DC current cancellation circuitry further comprises a driver circuitry configured to convert the residual current signal to the feedback signal.

10. The optical balanced homodyne receiver according to claim 1 wherein the receiver is further configured in a differential operating mode.

11. The optical balanced homodyne receiver according to claim 10 wherein the mixing element comprises two two-by-two tuneable mixers respectively driving two opposite opto-electric conversion circuitries thereby generating a pair of demodulated electrical current signals having a differential mode component.

12. The optical balanced homodyne receiver according to claim 1 wherein the receiver is further configured in a single-ended operating mode.

13. The optical balanced homodyne receiver according to claim 12 wherein the TI amplifier comprises a multistage inverting amplifier comprising a series of inverters.

14. The optical balanced homodyne receiver according to claim 1 wherein the optical mixing element comprises a Mach-Zehnder interferometer, a multimode interferometer with variable optical attenuators in each output arm, or a multimode interferometer with heat gradient.
